(19) United States
(12) Patent Application Publication
(10) Pub. No.: US 2024/0261789 A1
(43) Pub. Date: Aug. 8, 2024

(54) SAMPLE TUBE, SAMPLE TUBE CLOSING DEVICE AND METHOD FOR CLOSING A SAMPLE TUBE

(71) Applicant: Beckman Coulter, Inc., Brea, CA (US)

(72) Inventor: Christoph F. BRUGGAIER, Windach (DE)

(21) Appl. No.: 18/640,928

(22) Filed: Apr. 19, 2024

Related U.S. Application Data
(63) Continuation of application No. PCT/IB2022/059848, filed on Oct. 14, 2022.

(30) Foreign Application Priority Data
Oct. 20, 2021 (EP) 21203677.6

(51) Int. Cl. B01L 3/00

(52) U.S. Cl. CPC B01L 3/50825

(57) ABSTRACT

The present invention relates to a sample tube (10), a sample tube closing device for closing a sample tube (10) and a method of closing a sample tube (10), the sample tube (10) comprising:
a bottom portion (30),
a tubular portion (20), and an opening portion (40),
wherein the opening portion (40) comprises a foldable structure (41) configured to be foldable in a predetermined manner from an open state into a closed state.

The present invention relates to a sample tube, a sample tube closing device and a method for closing a sample tube.

Different sample tube systems are known in the art, a sample tube system generally comprising a sample tube and its closing means. Sample tubes are generally used for storing and/or transporting media, for example bodily fluids such as blood, urine or the like. After a sample of a certain media is drawn or filled into the sample tube, the sample tube is closed with a cap member which may be a screw cap or a rubber plug, whereupon the sample contained in the sample tube is transported to an examination facility, where the sample is examined. For examination of the sample, the cap is removed by unscrewing or unplugging, or the cap may be pierced with a needle in order to withdraw a specific amount of the sample to be examined. After withdrawal of the specific amount of the sample, the sample tube may be closed usually with a secondary cap.

In view of the above known sample tube system, an object of the present invention is to provide an improved sample tube system, in particular to provide a sample tube system with improved closing means, and to provide an improved method for closing a sample tube.

The problem is solved by the subject-matter of the independent claims. Preferred embodiments are defined by the dependent claims.

According to an aspect, a sample tube is provided, the sample tube comprising:
a bottom portion,
a tubular portion, and
an opening portion,
wherein the opening portion comprises a foldable structure configured to be foldable in a predetermined manner from an open state into a closed state.

Owing to the foldable structure of the opening portion of the sample tube, the sample tube advantageously provides for an improved sample tube system. Specifically, the sample tube provides for a sample tube system without the particular need of a separate cap member or plug member for closing the sample tube, in particular for a sample tube system without the need of a secondary cap. That is, the sample tube provides for a sample tube system which is closable without a cap member or plug member, particularly without a secondary cap. This advantageously reduces the manufacturing costs of the sample tube system, as the number of required parts is reduced. Furthermore, the sample tube particularly improves the handling of the sample tube system, since the closing means are always present with the sample tube itself.

In particular, the closed state may be a self-locked closed state. In other words, the closed state of the sample tube may particularly be a self-locked closed state of the sample tube.

Further owing to the foldable structure foldable into a closed state, particularly into a self-locked closed state, the sample tube provides for a closing or locking structure which does not open by itself but requires a predetermined minimum force applied to the opening portion being in the closed state, particularly the self-locked closed state, for opening the sample tube.

In preferred embodiments of the sample tube, the foldable structure being configured to be foldable in a predetermined manner allows for reversibly closing of the sample tube into the closed state or self-locked closed state. Owing to the foldable structure allowing for reversibly closing, repeated opening and closing of the sample tube is enabled, as no handling of a separate cap member is required. Even though the sample tube may generally be configured as a single-use sample tube, since the number of parts for providing a closable sample tube is reduced, also cleaning of a sample tube system, and thus, reusability of the sample tube system may be improved as well.

The term sample tube system as mentioned herein generally relates to a sample tube and its closing means. Thus, the sample tube of the present invention may also be referred to as a sample tube system.

As further mentioned herein, a closed state generally relates to a state of a sample tube different from an open state, and in which the opening of the sample tube is closed. Particularly, the closed state may define a folded state of the opening portion, wherein the opening portion is folded with respect to the opening portion in the open state, for example folded at least partially in a range of about 65° to about 135° or about 80° to about 110° with respect to the tubular portion, wherein the respective angle may be measured in a sectional side view of the sample tube, wherein the opening portion is folded at least toward an inside of the sample tube and the angle is measured as a deviation from the open state. The closed state may be a state which is fluid tight or which is not fluid tight. In particular, the closed state may comprise a state in which an opening or gap is maintained, which enables withdrawing of a sample or medium contained in the sample tube substantially without change to the closed state, for example by pipetting through the opening or gap. Nevertheless, the closed state of the sample tube preferably defines a state in which even when the sample tube tilts to a degree in which a medium contained in the sample tube flows to the opening portion and pushes against the opening portion in the closed state, a medium contained in the sample tube does not spill out.

With respect to deformations and movements of the foldable structure by pushing, pressing or other folding actions, said deformations and movements of the foldable structure preferably relate to resilient deformations and movements, further preferably to elastic deformations. Nevertheless, it is intended that also certain plastic deformations to the foldable structure are allowed as long as the closed state can be achieved or reached with the foldable structure.

Herein, in case a direction is given with the indication substantially or about, the respective direction may be understood to be in a range of 0° to 10°, preferably in a range of 0° to 5° deviating from the respective direction.

Herein, in case a measure or an amount is given with the indication substantially or about, the respective measure or amount may be understood to be in a range of 0% to 10%, preferably in a range of 0% to 5% deviating from the respective measure or amount.

An axis of the sample tube may generally be considered as a symmetrical axis of at least a portion of the sample tube, preferably of at least the tubular portion of the sample tube, similar to an axis of a cylinder.

An axial direction of the sample tube shall generally be considered as pointing from an inner surface portion of the bottom portion toward the opening portion of the sample tube and beyond said opening portion of the sample tube, preferably along the axis of the sample tube.

A radial direction of the sample tube may generally be considered as pointing from the axis of the sample tube to the circumferential surface of at least a portion of the sample tube. Preferably, the radial direction may be substantially perpendicular to the axis of the sample tube.

As mentioned herein, an axially inward direction or the terms axial inward, axially inward or inwards axially shall generally relate to a direction which is substantially parallel and opposite to an axial direction of the sample tube. In other words, the axial inward direction or the term axially inwards or inwards axially shall generally relate to a direction which is substantially parallel to the axis of the sample tube and points toward an inside of the sample tube, wherein the inside of the sample tube may be considered as the portion of the sample tube which faces a volume encompassed by the sample tube.

As mentioned herein, a radially inward direction or the terms radial inward, radially inward or inwards radially shall generally relate to a direction which is substantially parallel and opposite to a radial direction of the sample tube. Preferably, the radial inward direction or the terms radially inwards or inwards radially may be substantially perpendicular to the axial inward direction or the axial direction and substantially point toward the axis of the sample tube.

The present invention is not limited to sample tubes, such as primary tubes and secondary tubes, but may generally relate to a tube. A tube in this regard may generally be understood as a physical cavity, for example a bottle, a vial, a test tube, etc., which may particularly be configured to store media, and which may particularly be configured to be closed.

The bottom portion may also be referred to as a closed bottom portion or closed end of the sample tube which is connected to, preferably integrally formed with, the tubular portion of the sample tube. The bottom portion may comprise a closed shape, such as a hemispherical shape, a flat shape, or any kind of a curved or contoured shape.

The tubular portion of the sample tube may also be referred to as the body portion of the sample tube. The tubular portion may be a substantially cylindrical portion of the sample tube having a substantially cylindrical cross-section, for example.

The opening portion of the sample tube may also be referred to as the open end of the sample tube. The opening portion comprises the opening of the sample tube and is connected to, preferably integrally formed with, the tubular portion of the sample tube. The opening portion may be formed flush with the tubular portion and may have a cross-section that substantially corresponds to that of the tubular portion, except for the presence of the foldable structure. The axial end face of the opening portion may lie within a plane perpendicular to the axis of the sample tube.

Even though the sample tube according to the present invention is not in need of a separate cap member for closing the sample tube, the sample tube may be configured such that, when in the open state, it can be closed with a separate cap member or plug member. In particular, the sample tube may be configured to substantially resemble a conventional sample tube when in the open state, particularly with respect to shape, rigidity and/or strength, which improves usability of the sample tube, particularly since the sample tube may be used in conventional analysers.

In particular embodiments, the opening portion may include a coupling interface which may be configured to be coupled with a corresponding interface of a primary cap, for example a primary push cap. Particularly, the coupling interface may be provided at the outer circumferential surface of the opening portion, specifically, the radially outer circumferential surface of the opening portion. The outer circumferential surface of the opening portion may also be provided with a thread enabling the use of threaded cap members. Such a thread may be formed discontinuous so as not to interfere with the folding of the foldable structure.

In preferred embodiments of the sample tube, the foldable structure may be configured to be folded from the open state to the closed state upon application of at least a radial inward force and at least an axial inward force to at least a portion of the foldable structure.

Owing to the foldable structure configured to be folded into the closed state, the sample tube provides for a facilitated closing mechanism which can be implemented manually, automatically, or partially manually and automatically. Furthermore, owing to the foldable structure being configured to be folded from the open state to the closed state upon application of at least a radial inward force and at least an axial inward force, a simple and reproduceable folding mechanism may be provided by the foldable structure.

The at least a radial inward force may particularly be a force which is applied along the radial inward direction as defined above. Nevertheless, the radial inward force may also be a force which is applied in a direction which crosses a cross section of the sample tube, particularly which crosses a cross section of the sample tube without going through a center of the cross section of the sample tube, i.e. which crosses the cross section of the sample tube with an offset to the center of the cross section of the sample tube.

The at least an axial inward force may particularly be a force which is applied along the axial inward direction as defined above. The axial inward force may be applied substantially parallel to an axis of the sample tube. Nevertheless, the axial inward force may be applied in a direction which is inclined with respect to the axis of the sample tube, and which particularly facilitates a substantially axial movement or deformation of the sample tube. Furthermore, the axial inward force may be applied in a direction which at least partially and/or sequentially coincides with the axis of the sample tube, and/or in a direction which at least partially and/or sequentially has a predetermined offset from the axis of the sample tube.

In some embodiments, the foldable structure is configured to be folded from the open state sequentially
a) by application of a predetermined radially inward force onto the foldable structure and/or by forcing the foldable structure radially inward to a predetermined degree;
b) by application of a predetermined force on the foldable structure in a direction comprising at least the radial direction and/or a circumferential direction of the opening portion and/or by forcing the foldable structure radially inward and circumferentially around to a predetermined degree; and
c) by application of a predetermined axially inward force onto the foldable structure and/or by forcing the foldable structure axially inward to a predetermined degree.

Advantageously, step a) of the application of a predetermined radially inward force onto the foldable structure and/or forcing the foldable structure radially inward to a predetermined degree ensures the foldable structure of the opening portion to transition from the open state to a first partially folded state. Said first partially folded state relates to a state, wherein at least a part of the foldable structure of the opening portion is deformed with respect to the open state. The first partially folded state may particularly relate to a state, wherein at least a part of the foldable structure of the opening portion is deformed so as to at least partially protrude or incline radially inward the sample tube.

Advantageously, step b) of the application of a predetermined force on the foldable structure in a direction comprising at least the radial inward direction and/or a circumferential direction of the opening portion and/or forcing the foldable structure radially inward and circumferentially around to a predetermined degree ensures the foldable structure of the opening portion to transition from the first partially folded state to a second partially folded state. Said second partially folded state relates to a state, wherein at least a part of the opening portion is deformed with respect to the first partially folded state so as to at least partially further protrude or incline radially inward the sample tube than according to the first partially folded state. Furthermore, the second partially folded state may particularly relate to a state wherein at least a part of the foldable structure of the opening portion at least partially protrudes or inclines in circumferential direction of the sample tube. Particularly owing to the at least partially circumferential inclination of at least a part of the foldable structure of the opening portion, the foldable structure of the opening portion is lowered axially inwardly, so that an overlap of portions of the foldable structure is created when viewed in the axial direction and/or a radial direction.

Advantageously, step c) of the application of a predetermined axially inward force onto the foldable structure and/or forcing the foldable structure axially inward to a predetermined degree ensures the foldable structure of the opening portion to transition from the second partially folded state to the closed state, particularly the self-locked closed state. Said closed state relates to a state, wherein at least a part of the foldable structure of the opening portion is further deformed with respect to the second partially folded state, particularly in a direction axially inward of the sample tube. The closed state may particularly relate to a state wherein the foldable structure of the opening portion is self-biased against opening in a direction axially outward the sample tube. Preferably, the foldable structure of the opening portion is self-biased in the closed state in such a manner that a force required for opening the opening portion from the closed state into the open state is bigger than a force required to further push or deform the foldable structure of the opening portion axially inward of the sample tube.

Even though steps a), b) and c) have been indicated with the application of forces in a particular direction or by forcing the foldable structure in a particular direction, the deformation or movement resulting from said given force application or forcing of the foldable structure of the opening portion may include deformations of the foldable structure of the opening portion in more than in one direction. That is, by application of a predetermined radially inward force onto the foldable structure and/or by forcing the foldable structure radially inward to a predetermined degree according to a), the foldable structure of the opening portion may be configured to deform or move partially in the radial direction and/or partially in the circumferential direction and/or partially in the axial direction of the sample tube. Further, by application of a predetermined force on the foldable structure in a direction comprising at least the radial direction and/or a circumferential direction of the opening portion and/or by forcing the foldable structure radially inward and circumferentially around to a predetermined degree according to b), the foldable structure of the opening portion may be configured to deform or move partially in the radial direction and/or partially in the circumferential direction and/or partially in the axial direction of the sample tube. Furthermore, by application of a predetermined axially inward force onto the foldable structure and/or by forcing the foldable structure axially inward to a predetermined degree according to c), the foldable structure of the opening portion may be configured to deform or move partially in the radial direction and/or partially in the circumferential direction and/or partially in the axial direction of the sample tube. The deformation or movement of the foldable structure of the opening portion in a combination of particular directions may result from the opening portion being attached to or connected with the tubular portion, particularly attached to or connected with an axial end of the tubular portion, such that the foldable structure of the opening portion deforms or moves in three-dimensional manner.

Owing to the configuration of the closed state of the opening portion, the sample tube provides for a secure closure against spilling of a medium contained in the sample tube, while particularly allowing the contained medium to be withdrawn by pushing or piercing with a needle in an axially inward direction. Preferably, a needle may be pushed through the middle of the opening, such that the foldable structure of the opening portion itself is not pierced but rather pushed slightly open in an axially inward direction.

However, the sample tube is not limited to this type of medium withdrawal. In exemplary embodiments, medium may be withdrawn from the sample tube by direct piercing of the foldable portion of the opening portion, that is by piercing through a part of the foldable structure of the opening portion.

The above-mentioned steps a), b), c) are exemplary steps in an exemplary order of steps on the basis of which the foldable structure of the opening portion may be configured to be folded. In other preferable embodiments, only steps a) and c) may be applied, or steps a) and c) with a combination of a plurality of steps b) in between may be applied, or steps a) and b) may be applied in multiple alternating manner before step c).

In preferred embodiments of the sample tube, an axial extension of the foldable structure may be larger than a radius of the tubular portion.

The radius of the tubular portion may particularly relate to a radius of the sample tube, or generally half of a diameter or width of a cross section of the sample tube, particularly at an axial end of the tubular portion, for example at an axial end of the tubular portion to which the opening portion is attached and/or connected to.

Owing to the axial extension of the foldable structure being larger than a radius of the tubular portion, a preferable self-locking or self-biasing of the opening portion in the closed state can be ensured. Specifically, the foldable structure may be configured to form a substantially cone shape in the closed state, preferably a substantially cone shape being inclined or pointing axially inward the tubular portion. As the foldable structure generally leads to an at least partial overlap of respective portions of the foldable structure in the closed state, it is to be understood that the cone shape does not relate to a strict cone shape, but merely to a substantially cone shape, wherein portions of the foldable structure may for example extend beyond the peak or apex formed by the cone shape. However, the present invention is not limited to the foldable structure forming a cone shape in the closed state, and other shapes may be formed.

The self-locked closed state or self-biased closed state may in particular define a state wherein the foldable structure of the opening portion is respectively locked or biased against unfolding or against bringing the foldable structure from the closed state back into the open state. In exemplary embodiments, the foldable structure may be configured to be folded axially inward of the sample tube to a predetermined extent which secures the foldable structure to arrive at a stable self-locked or self-biased closed state. Said predetermined extent may be defined by a predetermined stable axial position of the foldable structure. The predetermined stable position may in particular depend on a lengthwise axial extension of the foldable structure, on a material of the foldable structure, on a wall thickness of the opening portion, and/or on a number of folding sections formed by the foldable structure. When folding or pushing the foldable structure axially inward, after a certain foregoing radial inward deformation, a force for folding or pushing the foldable structure axially inward, which may be defined as a closing force, increases first. Said first increase of the closing force may preferably take place up to a certain axial extent which may be called a dead center, wherein after the dead center is passed in the axial direction of the sample tube, the closing force for further folding or pushing the foldable structure axially inward into the closed state decreases. In some embodiments, the foldable structure may be configured to snap into the predetermined stable axial position of the closed state after passing the dead center. Said dead center may be located at a substantially axial location of a transition between the tubular portion and the opening portion, in particular between the tubular portion and the foldable structure of the opening portion. Said transition between the tubular portion and the opening portion, or between the tubular portion and the foldable structure of the opening portion may be defined by a substantially circumferential folding line which in turn may be defined or facilitated by a substantially circumferential groove.

Specifically, when folding or pushing the foldable structure axially inwards the tubular portion, an upper portion of the tubular portion, i.e. a portion of the tubular portion axially adjacent the opening portion or a portion of the tubular portion axially adjacent the foldable structure of the opening portion, may be configured to be radially deformed, preferably resiliently radially deformed. Said radial deformation of the upper portion of the tubular portion increases as an axial position of the axially inward folded or pushed foldable structure moves or deforms toward the dead center. In particular, when the foldable structure crosses a substantially axial location of the dead center axially inwards, the foldable structure may be configured to move or deform by itself, or at least with decreasing required axially inward force, into the predetermined stable axial position. During said movement or deformation of the foldable structure into the predetermined stable axial position, the radial deformation of the upper portion of the tubular portion decreases. Preferably, when the foldable structure reaches the predetermined stable axial position, the upper portion of the tubular portion reaches, or has already reached, a substantially radially undeformed state.

In preferred embodiments, the stable self-locked or self-biased state is configured to be reobtainable. Specifically, the self-locked or self-biased closed state may be reobtainable in that when an axial force is applied to the foldable structure further folding or pushing the foldable structure axially inward the sample tube, and after said axial force is removed. Furthermore, the self-locked or self-biased closed state may be reobtainable in that when an axial force is applied to the foldable structure, folding or pushing the foldable structure in a direction axially outward the sample tube, i.e. in an opening direction, and after said axial force in an axially outward direction is removed before crossing the dead center.

Owing to the above configuration of a self-locked or self-biased closed state of the foldable structure, an advantageous closed state may be secured, wherein spilling out and unintentional opening of the sample tube is prevented. Particularly, spilling out may be prevented by the foldable structure forming an at least substantially fluid tight seal in the closed state. Alternatively, spilling out may be prevented by the foldable structure forming a remaining opening or gap, wherein spilling is prevented by the capillary effect of a predetermined medium to be stored in the sample tube. Furthermore, after withdrawal of an amount of a contained media, for example by further pushing the foldable structure axially inward with a tube or needle or the like, the self-locked or self-biased closed state may be reached again after removal of said tube or needle.

In preferable embodiments, the axial extension of the foldable structure may be larger than 0.5 times a diameter of the opening portion. Preferably, the axial extension of the foldable structure may be in the range of about 0.5 to about 0.9 of the diameter of the opening portion, further preferably in the range of about 0.55 to about 0.7 of the diameter of the opening portion.

In preferred embodiments of the sample tube, the foldable structure may comprise grooves defining folding lines of the foldable structure in the closed state.

Advantageously, the grooves enhance the foldability of the foldable structure in that a resistance of the foldable structure to be folded is decreased at the grooves, and furthermore in that a plurality of folding lines of the foldable structure is predefined, such that a defined folding mechanism for folding the foldable structure in a predetermined manner is secured. In other words, the grooves define weakened portions of the foldable structure that guide the folding process from the open state to the closed state.

In preferred embodiments, the grooves comprised by the foldable structure may be integrally formed with the foldable structure, and furthermore may preferably be integrally formed with the opening portion, the tubular portion and/or the bottom portion of the sample tube. Integral forming of the grooves may as non-limiting examples be performed by injection molding. In particular, the mold for injection molding may be provided with protrusions for forming the grooves. In alternative embodiments, the grooves may be cut or chipped into the opening portion for example by a machining device, or stamped or embossed into the opening portion.

In preferred embodiments of the sample tube, the grooves may be formed on an outer circumferential surface of the opening portion and/or on an inner circumferential surface of the opening portion.

The provision of grooves on an inner circumferential surface of the opening portion enables providing a plane and even outer circumferential surface, which is advantageous when using plugs or caps contacting the outer circumferential surface. On the other hand, the provision of grooves on an outer circumferential surface of the opening portion enables providing a plane and even inner circumferential surface, which is advantageous for using plugs or caps contacting the inner circumferential surface. In any case, the axial end face of the opening portion may be formed without grooves, which is advantageous when using cap members of plugs of any type.

In preferred embodiments of the sample tube, the grooves may comprise:
a circumferential groove,
a plurality of axial grooves extending axially between the circumferential groove and an axial free end of the opening portion, and
a plurality of oblique grooves extending obliquely between the circumferential groove and the axial free end of the opening portion,
wherein optionally, the circumferential groove, the axial grooves and/or the oblique grooves are connected.

Owing to the combination of the circumferential groves with the plurality of axial grooves and the plurality of oblique grooves, a predetermined manner for folding the foldable structure is ensured. That is, the aforementioned combination of grooves particularly facilitates a defined and repeatable folding and unfolding the foldable structure of the sample tube. Furthermore, the aforementioned combination of grooves particularly supports manual folding or manually applied folding of the foldable structure, wherein even when forces applied to the foldable structure may not be ideally aligned for folding the foldable structure, the foldable structure still folds into the closed state in the predetermined manner at the combination of grooves which define the intended folding lines. Thus, a predetermined manner of folding the foldable structure may be ensured, even when the mechanism for actuating a folding mechanism to the foldable structure is varied. The folding mechanism may for example comprise manual folding, manual use of a sample tube closing device, and/or use of an automatic sample tube closing device. That is, even though different folding mechanisms may be applied to the foldable structure of the sample tube, the substantially same closed state, preferably the substantially same self-locked closed state may be arrived at, thus ensuring a repeatable quality of the closed state of the sample tube.

With regards to the respective grooves, the circumferential groove particularly facilitates a folding of the foldable structure radially inward with respect to the tubular portion of the sample tube. In some embodiments, the circumferential groove may be configured to extend fully circumferentially in a continuous manner. In alternative embodiments, the circumferential groove may be configured to extend discontinuously or sequentially circumferentially around, so as to extend not over the full 360° circumference, but in partial manner, for example with a plurality of circumferentially aligned grooves. The grooves may for example extend in a range of about 10° to about 170°, preferably in a range of about 30° to about 110° with respect to an axis of the sample tube. In exemplary embodiments, the circumferential groove in particular may define a substantially circumferential folding line, preferably between the tubular portion and the opening portion, specifically between the tubular portion and the foldable structure of the opening portion.

Furthermore, the plurality of axial grooves extending axially between the circumferential groove and the axial free end of the opening portion particularly facilitates a folding of adjacent portions of the foldable structure radially inward with respect to the respective axial grooves which preferably form a plurality of substantially axial folding lines. In some embodiments, an axial groove of the plurality of axial grooves may be configured to extend in straight manner. Alternatively or additionally, an axial groove of the plurality of axial grooves may be configured to extend discontinuously or sequentially in the axial direction of the sample tube. In some embodiments, an axial groove of the plurality of axial grooves may be configured to be connected with the circumferential groove, or with one of the plurality of circumferentially aligned grooves.

The plurality of oblique grooves extending obliquely between the circumferential groove and the axial free end of the opening portion particularly facilitates a folding of portions of the foldable structure at least partially in circumferential direction with respect to the axis of the sample tube, such that neighboring portions or sections of the foldable structure start overlapping one another when viewed from the axial and/or a radial direction of the sample tube. In some embodiments, an oblique groove of the plurality of oblique grooves may be configured to extend in straight manner or in continuously curved manner. Particularly, an oblique groove of the plurality of oblique grooves may be configured to extend in straight manner in a region between the circumferential groove and the axial free end of the opening portion and/or in a partly or continuously curved manner in a region between the circumferential groove and the axial free end of the opening portion. The curved and straight manner as an extension of an oblique groove as mentioned herein, may particularly relate to a direction when viewing the opening portion of the sample tube in a plan view in an unwound or uncoiled state. Alternatively or additionally, an oblique groove of the plurality of oblique grooves may be configured to extend discontinuously or sequentially in a direction between the circumferential groove and the axial free end of the opening portion. In some embodiments, an oblique groove of the plurality of oblique grooves may be configured to be connected with the circumferential groove or with at least one of the plurality of circumferentially aligned grooves, and/or with at least one of the axial grooves of the plurality of axial grooves. In exemplary embodiments, an oblique groove of the plurality of oblique grooves may be inclined with respect to the circumferential groove in a range of about 10° to about 88°, preferably in a range of about 30° to about 85°, further preferably in a range of about 60° to about 83°, when viewed from the side of the sample tube with respect to an axis of the sample tube.

In preferred embodiments, the plurality of oblique grooves comprises the same number of grooves as the plurality of axial grooves. This advantageously enhances the folding mechanism wherein a portion formed between one oblique groove and one axial groove starts to fold in an at least partially circumferential manner.

Further to the above mentioned preferable, exemplary and alternative extensions of the circumferential groove, the plurality of axial grooves and the plurality of oblique grooves, other extensions are possible and may be determined on the basis of the desired material combination for the sample tube, the geometry of the sample tube, the desired folding mechanism, and/or the desired self-locking or self-biasing closed state.

Furthermore, in some embodiments, only one or two of the three of the circumferential groove, the plurality of axial grooves and the plurality of oblique grooves may be disposed at the foldable structure of the opening portion and preferably be determined on the basis of the desired material combination for the sample tube, the geometry of the sample tube, the desired folding mechanism, and/or the desired self-locking or self-biased closed state.

Still further, additional grooves in addition to the preferable, exemplary and alternative ones as emphasized above may be integrally or separately formed at or in the foldable structure.

In preferred embodiments of the sample tube, in the closed state, a plurality of substantially symmetrical folding sections are radially folded inward, wherein the number of folding sections is preferably four.

Owing to the substantially symmetrical folding sections, preferably being four, the foldable structure of the sample tube can easily be manually, automatically, or semi-automatically folded, particularly folded from the open state to the closed state of the sample tube.

Nevertheless, in alternative embodiments, the opening portion of the sample tube may have a foldable structure with two, three, five, six, seven, eight, nine, ten, eleven, twelve, thirteen, fourteen, fifteen, sixteen, seventeen, eighteen, nineteen, twenty or more folding sections, preferably but not necessarily limited to symmetrical folding sections.

In case the folding sections are provided as symmetrical folding sections, said folding sections are generally considered as being substantially symmetrical, particularly rotation symmetrical, with respect to an axis of the sample tube.

In preferred embodiments of the sample tube, the foldable structure may be formed integrally with the opening portion, preferably by injection molding.

Particularly, the opening portion which the sample tube comprises may be integrally formed with at least the tubular portion and/or with the bottom portion of the sample tube. Further, the grooves comprised by the foldable structure may be integrally formed with the foldable structure, and furthermore may preferably be integrally formed with the opening portion, the tubular portion and/or the bottom portion of the sample tube. Integral forming of the grooves may be performed by injection molding. In alternative embodiments, the grooves may be cut or chipped into the opening portion for example by a machining device, or stamped or embossed into the opening portion.

Preferably, the sample tube as a whole may be integrally formed by injection molding, particularly by one molding step of injection molding.

The foldable structure being integrally formed with the opening portion and at least one of the tubular portion and the bottom portion particularly provides for an improved sample tube system, wherein a means for closing the sample tube is integrally provided with the sample tube itself. This advantageously further improves manufacturing of a sample tube system formed by a sample tube and means for closing the sample tube, as the number of separate parts is reduced. The reduced number of separate parts furthermore in particular improves the handling of the sample tube system, as the closing means are always present with the sample tube itself.

Owing to the integrally formed foldable structure, the sample tube allows for enhanced reversibly closing, that is, it allows for repeated opening and closing of the sample tube, particularly since no handling of a separate cap member is required. Since the number of parts for providing a closable sample tube is reduced, also cleaning of a sample tube system may be simplified, and consequently, reusability of the sample tube system may be improved in respective applications.

Preferred materials for partially or integrally forming a sample tube according to the present invention are polyethylene (PE), high density polyethylene (HDPE), low density polyethylene (LDPE), polypropylene (PP), polycarbonate (PC), Polytetrafluoroethylene (PTFE), a silicone, and/or other particularly biocompatible material. However, the materials suitable for manufacturing the sample tube according to the present invention are not limited to the above-mentioned materials but may comprise also a combination of the above-mentioned materials and/or include other materials, particularly polymers or reinforced polymers, generally suitable for injection molding, multi component injection molding and/or extrusion molding. In some embodiments, the sample tube may include or substantially consist of more than one material, particularly include or substantially consist of two materials, particularly selected from the above mentioned materials.

In alternative embodiments, the foldable structure and in particular the opening portion of the sample tube, may be formed non-integrally with the tubular portion of the sample tube. For example, the opening portion including the foldable structure may be connected to the tubular portion of the sample tube by a separate step, such as by welding or via an adhesive.

In particular embodiments, the sample tube may be configured to be closable with a separate cap member or plug member when in the open state.

In some embodiments, the opening portion of the sample tube may include a coupling interface which may be configured to be coupled with a corresponding interface of a separate cap member or a plug member, which may for example be a primary cap.

In particular embodiments, an outer circumferential surface of the opening portion may include a thread, such that the sample tube is configured to be closable with a threaded cap member.

Owing to the sample tube being closable with a separate cap member while having a foldable portion, an improved sample tube may be provided which may be closed with two different closing means. Furthermore, an improved sample tube may be provided which allows for securing a sterile state before drawing a sample or medium into the sample tube, and which may then be closed for providing the contained sample or medium to an analysis facility.

In some embodiments, the outer circumferential surface of the opening portion may include an interface different from a thread, specifically suitable to provide for a form fit and/or friction fit with a separate cap member, particularly a primary cap.

According to another aspect, a sample tube closing device for closing a sample tube, particularly a sample tube according to any of the aforementioned aspects, preferable, exemplary and alternative embodiments, is provided, the sample tube closing device comprising:
a pressing element configured such that upon operation of the sample tube closing device, at least a portion of the foldable structure is first radially pressed inwards and subsequently at least partially pressed inwards axially to fold the foldable structure into the closed state.

The aforementioned exemplary, preferable and alternative aspects and embodiments of the sample tube, along with their advantageous effects, also respectively apply to the sample tube closing device.

Owing to the sample tube closing device, closing of the sample tube, i.e. bringing the sample tube from the open state into the closed state, is simplified.

In exemplary embodiments, the sample tube closing device may be a hand-held mechanic sample tube closing device. In other exemplary embodiments, the sample tube closing device may be an automatic sample tube closing device or a robot. In exemplary embodiments, the sample tube closing device and in particular the pressing element of the sample tube closing device may be configured to fold the foldable structure of the sample tube upon insertion of the sample tube into a receiving portion of the sample tube closing device, or upon guiding the sample tube closing device along a predetermined axial length of the sample tube. Furthermore, the sample tube closing device may include one or more buttons or actuators to actuate the pressing element or a plurality of pressing elements, respectively. The pressing element of the sample tube closing device may be configured to radially press at least a portion of the foldable structure radially pressed inwards first, and to axially press at least a portion of the foldable structure axially inwards into the closed state afterwards. When a plurality of pressing elements are provided, the respective pressing elements may be configured to engage different portions of the foldable structure in a predetermined sequence and manner.

In preferred embodiments of the sample tube closing device, the sample tube closing device may be operated by an axial displacement and/or by a rotational displacement with respect to the sample tube.

The sample tube closing device being operated by an axial displacement and/or a rotational displacement with respect to the sample tube provides for a simplified sample tube closing device.

In exemplary embodiments, the sample tube closing device may include one or more buttons or actuators to actuate the pressing element or pressing elements so as to radially displace and/or axially displace and/or rotationally displace at least a portion of the foldable structure. In exemplary embodiments, radial displacement and/or axial displacement and/or rotational displacement may be applied sequentially by the sample tube closing device onto a foldable structure of a sample tube. In other exemplary embodiments, at least two of the three of radial displacement and/or axially displacement and/or rotationally displacement may be applied simultaneously by the sample tube closing device onto a foldable structure of a sample tube.

In some embodiments, the pressing element may include an axial plunger which may have a slanted front face which is configured to push the foldable structure of the opening portion at multiple points simultaneously along the slanted front face. The slanted front face may particularly be shaped so as to substantially fold the foldable structure toward the closed state. The slanted front face may particularly be shaped so as to sequentially and/or partially concurrently radially inwards and/or axially inwards.

According to another aspect, a sample tube opening device for opening a sample tube, particularly a sample tube according to any of the aforementioned aspects, preferable, exemplary and alternative embodiments, is provided. The sample tube opening device may particularly comprise a pulling element and a hooking element disposed at an end of the pulling element.

In preferable embodiments, the sample tube opening device is configured to be at least partially inserted into a closed sample tube, i.e. a sample tube having a foldable structure being folded in a closed state. In particular the hooking element may be configured to be inserted into the closed sample tube in axially inward direction of the sample tube. Upon insertion of at least the hooking element, the pulling element is configured to be pulled axially outwards, i.e. in a direction from the closed state into an open state of the sample tube, preferably an unfolded open state of the sample tube, such that the hooking element engages at least a portion of the foldable structure and pulls at least the portion of the foldable structure axially outward. In preferable embodiments of the sample tube, the foldable structure comprises a plurality of folding sections at least partially overlapping one another in the closed state, so that even in case only one folding section of the plurality of folding sections is pulled axially outward by the hooking element disposed at the end of the pulling element, the whole foldable structure is unfolded or pulled from the closed state into the open state of the sample tube.

In exemplary embodiments, the pulling element may have an oblong shape having a first axial end and a second axial end. The hooking element may be formed as a protrusion disposed at the second axial end of the pulling element. Specifically, the hooking element may have the form of a barbed hook and particularly protrude radially outwardly from the second axial end. The hooking element may be configured to be elastically deformable radially inwards, so as to facilitate insertion thereof into the sample tube in the closed state. The hooking element may have any shape suitable for pulling or unfolding the foldable structure of the sample tube form the closed state into the open state.

Owing to the aforementioned sample tube opening device, a simple and efficient device for opening a closed sample tube is provided.

The aforementioned exemplary, preferable and alternative aspects and embodiments of the sample tube and the sample tube closing device along with their advantageous effects, also respectively apply to the sample tube opening device.

According to another aspect, a method for closing a sample tube is provided, the method comprising the steps of:
providing a sample tube having a foldable structure at an opening portion, the sample tube particularly being a sample tube according to any of the aforementioned aspects, preferable, exemplary and alternative embodiments;
radially pressing at least a portion of the foldable structure radially inwards; and
axially pressing at least a portion of the foldable structure axially inwards into a closed state.

The aforementioned exemplary, preferable and alternative aspects and embodiments of the sample tube, the sample tube closing device and the sample tube opening device, along with their advantageous effects, also apply respectively to the method for closing a sample tube.

Owing to the method of closing a sample tube, an improved closing of the sample tube, i.e. bringing the sample tube from the open state into the closed state, is enabled in a simple manner.

In preferred embodiments of the method of closing a sample tube, the method may comprise the step of:
pressing at least a portion of the foldable structure in a direction comprising at least a radial inward direction and/or a circumferential direction of the sample tube, preferably between the steps of radially pressing and axially pressing.

Owing to the additional step which is preferably performed after the step of radially pressing at least a portion of the foldable structure radially inwards and before the step of axially pressing at least a portion of the foldable structure axially inwards into a closed state, a rotational folding of the foldable structure is facilitated so that from an above view, folding sections of the foldable structure or portions of the foldable structure start overlapping one another. In other words, owing to the pressing of at least a portion of the foldable structure in the direction comprising at least the radial inward direction and/or the circumferential direction, neighboring folding sections or neighboring portions of the foldable structure start overlapping one another, when viewed in the axial and/or a radial direction.

In preferred embodiments of the method of closing a sample tube, the method may comprise radially displacing at least a portion of the foldable structure of the sample tube, and/or rotationally displacing at least a portion of the foldable structure of the sample tube, and/or axially displacing at least a portion of the foldable structure of the sample tube.

In exemplary embodiments, radially displacing and/or rotationally displacing and/or axially displacing may be applied sequentially. In other exemplary embodiments, at least two of the three of radial displacing and/or rotationally displacing and/or axially displacing may be applied simultaneously.

These and other objects, features and advantages of the present invention will become more apparent upon reading of the following detailed description of preferred embodiments and accompanying drawings. It should be understood that even though embodiments are separately described, single features thereof may be combined to additional embodiments.

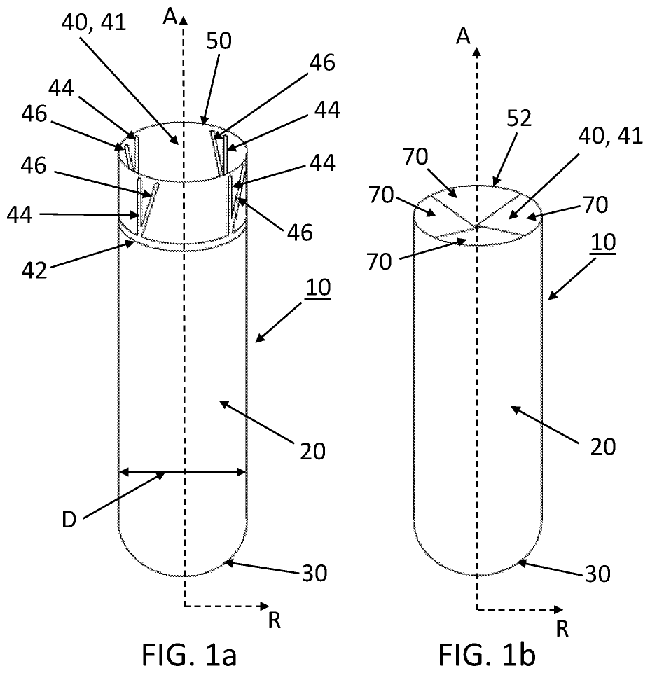

FIG. 1a shows an exemplary embodiment of a sample tube in an open state in an oblique view;

FIG. 1b shows an exemplary embodiment of a sample tube in a closed state in an oblique view;

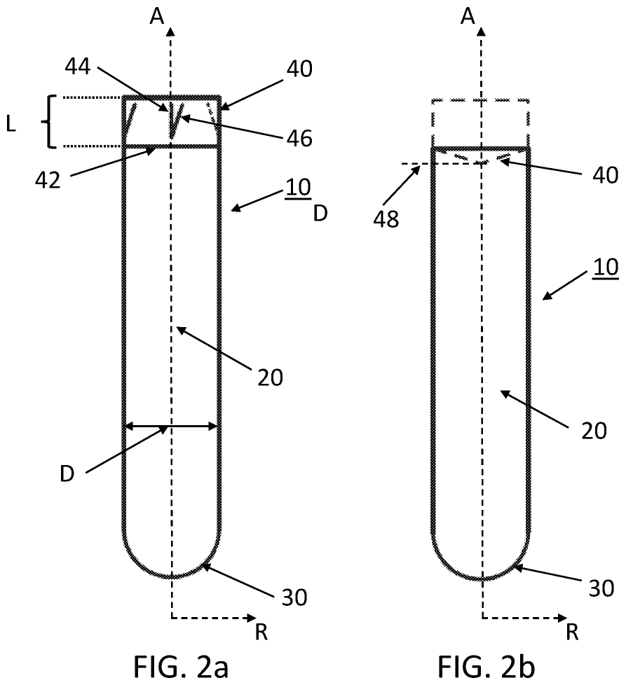

FIG. 2a shows an exemplary embodiment of a sample tube in an open state in a side view;

FIG. 2b shows an exemplary embodiment of a sample tube in closed state in a side view;

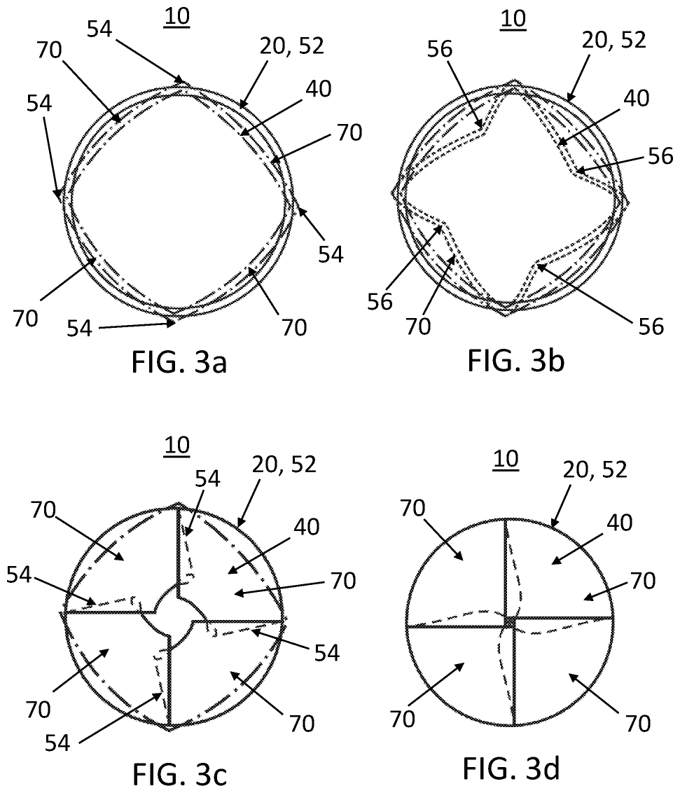

FIG. 3a shows an exemplary embodiment of a sample tube in a partially closed state in a top view;

FIG. 3b shows an exemplary embodiment of a sample tube in another partially closed state in a top view;

FIG. 3c shows an exemplary embodiment of a sample tube in still another partially closed state in a top view;

FIG. 3d shows an exemplary embodiment of a sample tube in a closed state in a top view;

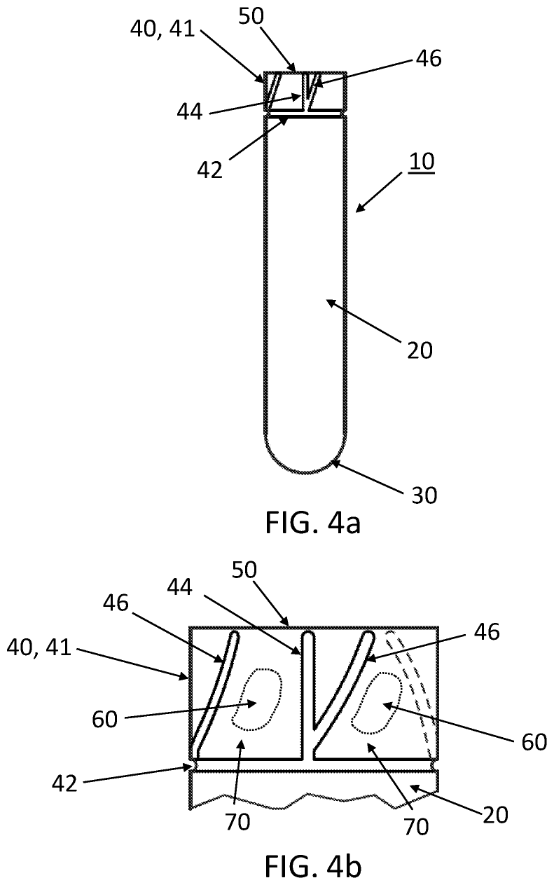

FIG. 4a shows an exemplary embodiment of a sample tube in an open state in a side view;

FIG. 4b shows an enlarged opening portion of an exemplary embodiment of a sample tube in an open state in a side view;

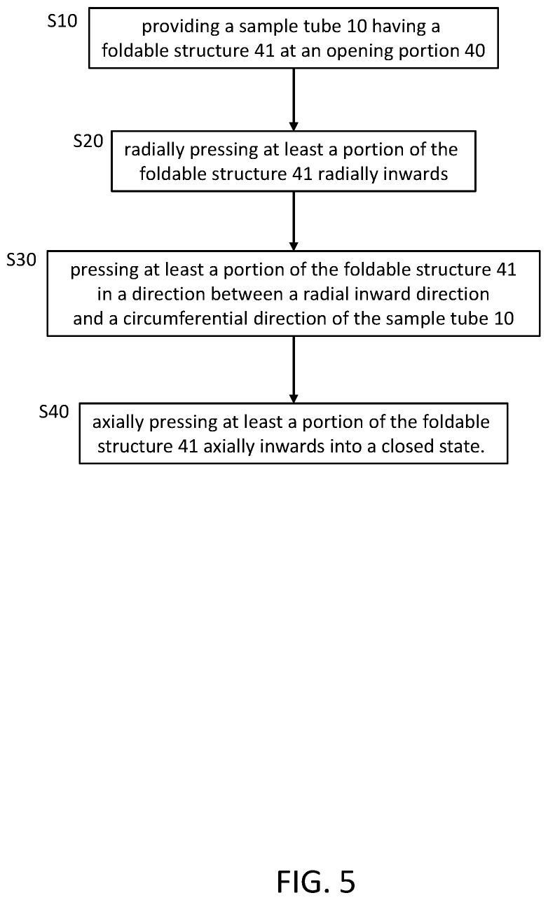

FIG. 5 shows a flow chart representing an exemplary method for closing a sample tube according to an embodiment;

FIG. 1a shows an exemplary embodiment according to the present invention wherein a sample tube 10 is shown in an open state in an oblique view. As illustrated in FIG. 1a, the sample tube 10 has a bottom portion 30 at its axial lower end. As exemplarily shown in FIG. 1, the bottom portion 30 is integrally formed with a tubular portion 20 and integrally formed with an opening portion 40, wherein the opening portion 40 includes a foldable structure 41, preferably integrally formed with the opening portion 40.

As shown in FIG. 1a, the sample tube 10 comprises a closed bottom portion 30 at a bottom end of the sample tube 10. The tubular portion 20 extends from the bottom portion 30 in an upward direction, in particular along an axial direction A of the sample tube 10. As indicated in FIG. 1a, the tubular portion 20 may have a substantially constant diameter D. However, the present invention is not limited to a sample tube 10 with a tubular portion 20 having a substantially constant diameter D. In alternative embodiments, the tubular portions 20 may have a different shape, different from a constant diameter D. For example, the tubular portion 20 may have an oval, polygonal, inclined or otherwise contoured shape.

Whereas the tubular portion 20 preferably extends between the bottom portion 30 and the opening portion 40 of the sample tube 10, the opening portion 40 preferably extends from an upper end or upper edge of the tubular portion 20 in an axial direction A with a predetermined length L or axial extension L (not shown in FIG. 1a but particularly emphasized in FIG. 2a). The opening portion 40 specifically extends in the axial direction A up to a free end 50 of the opening portion 40, such that the free end 50 forms an upper end of the sample tube 10 in the open state. Nevertheless, since the tubular portion 20 and the opening portion 40 preferably are integrally formed, the tubular portion 20 generally does not have a distinct upper edge but rather transitions to the opening portion 40.

However, and as exemplarily shown in FIG. 1a, the foldable structure 41 of the opening portion 40 particularly may comprise a circumferential groove 42 which indicates an upper end or upper edge of the tubular portion 20, wherefrom the opening portion 40 preferably extends in the axial direction A.

As further shown in FIG. 1a, the foldable structure 41 of the opening portion 40 of the sample tube 10 may particularly include a plurality of axial grooves 44, as well as a plurality of oblique grooves 46. As shown in FIG. 1a, the axial grooves 44 and the oblique grooves 46 may be configured to be connected with the circumferential groove 42 at respective connecting spots.

In other embodiments, the grooves 42, 44, 46 may be configured as not connected to one another. In further other embodiments only one or two of the kinds of grooves 42, 44, 46 may be provided at the foldable structure 41.

In still other embodiments, at least the circumferential groove 42 and at least some of the axial grooves 44 may be connected. In further embodiments, each oblique groove of the plurality of oblique grooves 46 may be connected to one axial groove 44, wherein the axial groove 44 however is not connected to the circumferential groove 42. In still further embodiments, each oblique groove of the plurality of oblique grooves 46 may be connected to one respective axial groove 44 of the plurality of axial grooves 44, while each axial groove 44 of the plurality of axial grooves 44 is connected to the circumferential groove 42.

As indicated in FIG. 1a, a groove of the circumferential groove 42, of the plurality of axial grooves 44 and of the plurality of oblique grooves 46 may be provided on either an outer circumferential surface of the opening portion 40 or an inner circumferential surface of the opening portion 40. The outer circumferential surface of the opening portion 40 being generally considered as facing an outside of the sample tube 10 particularly in a radial direction R. The inner circumferential surface of the opening portion 40 being generally considered as facing the axis A of the sample tube 10, particularly in direction parallel and opposite to the radial direction R.

FIG. 1b shows an exemplary sample tube 10 according to the present invention wherein the sample tube 10 is in a closed state. The sample tube 10 is similar to the one shown in FIG. 1a, such that substantial explanations given thereto particularly regarding the sample tube 10 with the bottom portion 30 and the tubular portion 20 apply accordingly.

However, as specifically shown in FIG. 1b, the sample tube 10 is in a closed state, the closed state preferably being a self-locked or a self-biased closed state. As exemplarily shown in FIG. 1b but not to be considered as limiting, the self-locked or self-biased closed state is arrived at a state, wherein the foldable structure 41 of the opening portion 40 is particularly folded axially inward the sample tube 10 so as to form a cone shape. The closed state is preferably formed by a number of folding sections 70, wherein neighboring folding section 70 at least partially overlap one another, and wherein further preferably, the number of folding sections 70 form an axially inward inclined cone shape at an upper axial end of the sample tube 10, i.e. at an upmost portion of the sample tube 10 in the axial direction A.

FIG. 2a shows an exemplary sample tube 10 according to the present invention wherein a sample tube 10 is shown in an open state in a side view, similar to the sample tube 10 shown in FIG. 1a.

As particularly indicated in FIG. 2a, the tubular portion 20 of the sample tube 10 may have a substantially constant inner and/or outer diameter D. Nevertheless, the sample tube 10 shall not be limited to this, such that in particular the tubular portion 20 also may have a contoured shape with varying diameter, or with a shape not defining a specific diameter.

As specifically indicated in FIG. 2a, the opening portion 40 of the sample tube 10 extends with a length L or axial extension L from the tubular portion 20 along the axial direction A up to the free end 50. The lower end of the opening portion 40 in the axial direction A is preferably formed by the circumferential groove 42 which may form a circumferential folding line 52 when folding the foldable structure 41 of the opening portion 40 at least partially radially in inward, i.e. parallel to a radial direction R toward the axial middle indicated by the axis A.

In preferred embodiments, the length L or the axial extension L of the foldable structure 41 may be at least half of the diameter D of the opening portion 40, which may be the substantially same diameter D of the tubular portion 20. Preferably, the axial extension L of the foldable structure 41 may be in the range of about 0.5 to about 0.9 of the diameter D of the opening portion 40, further preferably in the range of about 0.55 to about 0.7 of the diameter D of the opening portion 40.

The foldable structure 41 having the axial extension L of at least half of the diameter D of the opening portion 40 particularly allows for the foldable structure 41 to be folded into the closed state as indicated in FIG. 2b with a dashed line which forms a cone shape being inclined axially inward the tubular portion 20 of the sample tube 10. That is, the foldable structure 41 when being in the closed state may form a cone shape, wherein the foldable structure 41 is inclined with respect to the axial direction A. For example, the cone shape may be inclined such that the foldable structure 41 extends from the circumferential folding line 52 at least partially axially inward the tubular portion 20.

Furthermore, the transition of the foldable structure 41 of the opening portion 40 is shown in FIG. 2b, wherein the original opening portion 40 in the open state is shown with dashed lines rectangularly extending above the tubular portion 20 of the sample tube 10, and wherein the closed state of the foldable structure 41 of the opening portion 40 is indicated with dashed lines forming a triangular or cone shape extending below the upmost end of the tubular portion 20 of the sample tube 10.

As indicated in FIG. 2b, the foldable structure 41 of the opening portion 40 preferably extends axially inward the tubular portion 20 to a predetermined stable axial position 48. The foldable structure 41 extending to the predetermined stable axial position 48 may be configured to define a predetermined self-locked or self-biased closed state which on the one hand facilitates or allows withdrawal of a medium or sample contained in the sample tube 10, for example by pushing the foldable structure 41 further axially inward with a predetermined sampling force, but which on the other hand prevents spilling of a medium when the sample tube 10 is tilted or flipped upside-down, and wherein an opening of the foldable structure 41 in the axial direction A is only effected upon application of a predetermined opening force. In preferable embodiments, a magnitude of the predetermined opening force is configured to be greater than a magnitude of the predetermined sampling force.

The predetermined stable axial position 48 may furthermore define a level of axial inward inclination of the foldable structure 41 in the closed state which the foldable structure 41 is configured to reobtain after removal of the predetermined sampling force.

FIGS. 3a, 3b, 3c and 3d show exemplary states of the foldable structure 41 of the opening portion 40 when the sample tube 10 according to the invention transitions from the open state (see FIGS. 1a and 2a) to the closed state (see FIGS. 1b and 2b).

For illustrative purposes, an exemplary wall thickness of the tubular portion 20 and the foldable portion 41 of the opening portion 40 is particularly shown in FIGS. 3a und 3b but neglected in the illustrations of FIGS. 3c and 3d. Nevertheless, the different states as shown in FIGS. 3a, 3b, 3c and 3d shall be considered as generally relating to the same sample tube 10 which has different intermediate states in the transition from the open state to the closed state.

FIG. 3a shows a first transition from the open state of the sample tube 10 to a first partially closed state. Specifically, the original open state of the sample tube 10 is indicated with full lines, wherein the opening portion 40 in particular may have the same wall thickness and diameter D as the tubular portion 20. Nevertheless, in alternative embodiments, the opening portion 40 may have a different shape and/or wall thickness and/or diameter than the tubular portion 20 also in the open state of the sample tube 10. The first partially closed state of the sample tube 10 is indicated with dashed lines in FIG. 3a, wherein a portion of the tubular portion 20 nevertheless substantially maintains the shape as indicated with the full lines. In the first partially closed state, a majority of the foldable structure 41 of the opening portion 40 protrudes at least partially radially inward with respect to the tubular portion 20. As further indicated in FIG. 3a, in the first partially closed state of the sample tube 10, a part of the sample tube 10 may deform radially outward with respect to the tubular portion 20 in the open state, wherein said radial outward deformation preferably is a resilient deformation, in particular an elastic deformation. Said radially outward deformed portion is preferably formed by an upper portion of the tubular portion 20 and/or at least a part of an axial folding line 54 which may in particular be formed or at least be facilitated by an axial groove 44 as illustrated in FIGS. 1a, 1b, 2a and 2b.

FIG. 3b shows a second transition from the first partially closed state of the sample tube 10 as illustrated in FIG. 3a to a second partially closed state. Specifically, the first partially closed state of the sample tube 10 is in particular indicated with dashed lines being dashed in the same manner as shown in FIG. 3a. The second partially closed state of the sample tube 10 is indicated with dashed lines being dashed in another manner than those for indicating the first partially closed state as indicated in FIG. 3a. Specifically, in the second partially closed state a majority of the foldable structure 41 of the opening portion 40 protrudes at least partially further radially inward with respect to the tubular portion 20 than the majority of the foldable structure 41 as shown in the first partially folded state. As further indicated in FIG. 3b, in the second partially closed state of the sample tube 10, a part of the majority of the radially inward protruding foldable structure 41 is inclined with respect to the other part of the majority of the radially inward protruding foldable structure 41. Through the above view of FIG. 3b, an axially upmost tip of an oblique folding line 56 is indicated which may preferably be formed or at least be facilitated by an oblique groove 46 as illustrated in FIGS. 1a, 1b, 2a and 2b. Through the oblique folding lines 56 preferably formed by the respective oblique grooves 46, an at least partially folding of the foldable structure 41 in a circumferential direction is facilitated, such that folding sections 70 which may be formed between adjacent axial folding lines 54 may start overlying or overlapping one another when viewed from above, as particularly illustrated in FIG. 3c.

FIG. 3c shows a third transition from the second partially closed state of the sample tube 10 as illustrated in FIG. 3b to a third partially closed state. The third partially closed state of the sample tube 10 is indicated with full and dashed lines in combination, wherein lines representing parts of the foldable structure 41 considered to be seen when viewed from above are drawn as full lines, and wherein lines representing parts of the foldable structure 41 considered as not to be seen when viewed from above are drawn as dashed lines. Specifically, in the third partially closed state, the folding structure 41 of the opening portion 40 is in an almost closed state, wherein folding sections 70 of the foldable structure 41 protrude at least partially further radially inward with respect to the tubular portion 20 than the majority of the foldable structure 41 according to the second partially folded state. As further indicated in FIG. 3c, neighboring folding sections 70, each folding section 70 formed between adjacent axial folding lines 54, at least partially overlap one another in a circumferential direction. Owing to an increase of the at least partially overlap of neighboring folding sections 70 in the circumferential direction when pressing the foldable structure 41 axially inwards accompanied by a radially outward deformation of an upper portion of the tubular portion 20, a force required for pressing the foldable structure 41 axially inwards, that is parallel and opposite to the axial direction A as shown in FIG. 1a for example, increases.

FIG. 3d shows a fourth transition from the third partially closed state of the sample tube 10 as illustrated in FIG. 3c to the closed state. The closed state of the sample tube 10 is indicated with full and dashed lines in combination, wherein lines representing parts of the foldable structure 41 considered to be seen when viewed from above are drawn as full lines, and wherein lines representing parts of the foldable structure 41 considered as not to be seen when viewed from above are drawn as dashed lines. Specifically, in the closed state, neighboring folding sections 70 of the foldable structure 41 further overlap one another, in particular in circumferential direction of the sample tube 10, compared to the third partially folded state as shown in FIG. 3c. As furthermore indicated in FIG. 3d, the tubular portion 20, in particular the upper portion of the tubular portion 20 may have reobtained a substantially cylindrical shape, when the sample tube 10 is in the closed state.

FIG. 4a shows an exemplary embodiment of a sample tube 10 according to the present invention in a side view. Further to the exemplary embodiment of a sample tube 10 shown in FIG. 2a, the sample tube 10 as shown in FIG. 4a particularly illustrates the sample tube 10 having a foldable structure 41, wherein a circumferential groove 42 is disposed at an outer circumferential surface of the sample tube 10. This provides the sample tube 10 with an improved foldability of the foldable structure 41 with respect to the tubular portion 20 of the sample tube 10 and at the same time allows the sample tube 10 to have a straight inner circumferential surface, thus being particularly easy to clean and therefore suitable to be reused, and furthermore allows a particularly secure sealing with a plug.

Further, one or more of the grooves of the axial grooves 44 and the oblique grooves 46 may be disposed on the outer circumferential surface of the sample tube 10 or on the inner circumferential surface of the sample tube 10.

FIG. 4b shows an enlarged side view of the foldable portion 41 of the opening portion 40 of the sample tube 10. In FIG. 4b preferred force application portions 60 are shown with dashed lines in between an axial groove 44 and an oblique groove 46. In preferred embodiments and as indicated in FIG. 4b, the number of axial grooves 44 may be the same as the number of oblique grooves 46 which the foldable structure 41 comprises. Preferably, an oblique groove 46 extends obliquely from an axial groove 44. Further preferably, a preferred force application portion 60 is disposed between an axial groove 44 and an adjacent oblique groove 46 which is not the oblique groove 46 which extends obliquely from the axial groove 44. In other words, in case the number of axial grooves 44 is the same as the number of oblique grooves 46, such that each oblique groove 46 is disposed between two axial grooves 44, the preferred force application portions 60 is disposed between an axial groove 44 and its adjacent most distant oblique groove 46. In still other words, in case the number of axial grooves 44 is the same as the number of oblique grooves 46, wherein each oblique groove 46 is disposed between two axial grooves 44, the preferred force application portions 60 is disposed between an axial groove 44 and its adjacent oblique groove 46 which is more distant than the other adjacent oblique groove 46.

As shown in FIG. 4b, the preferred force application portion 60 extends over a certain area of the foldable structure 41 or over a certain area of each folding section 70 of the foldable structure 41, since the grooves 42, 44, 46 ensure the folding of the foldable structure 41 in a predetermined manner even in case a certain force is not applied at an exact point or in an exact direction.

FIG. 5 shows a flow chart representing an exemplary method for closing a sample tube 10 according to an embodiment. As shown in FIG. 5, the method of or for closing a sample tube 10 particularly includes the steps of:
S10: providing a sample tube 10 having a foldable structure 41 at an opening portion 40;
S20: radially pressing at least a portion of the foldable structure 41 radially inwards;
S30: pressing at least a portion of the foldable structure 41 in a direction between a radial inward direction and a circumferential direction of the sample tube 10; and
S40: axially pressing at least a portion of the foldable structure 41 axially inwards into a closed state.

Owing to the sequential steps S10, S20, S30 and S40, wherein further steps of radially inward pressing, axially inward pressing, and/or pressing radially inward and circumferentially around to a predetermined degree may be performed in between the above-mentioned steps S10, S20, S30 and S40, a secure and efficient mechanism for closing a sample tube is provided. Furthermore, in alternative embodiments, at least one of the steps S20 and S30 may be omitted. Still further, other pressing, pulling and general folding steps may be applied for folding the foldable structure 41 of the sample tube 10 in predetermined manner into the closed state of the sample tube 10.

### LIST OF REFERENCE NUMERALS

10 sample tube
20 tubular portion
30 bottom portion
40 opening portion
41 foldable structure
42 circumferential groove
44 axial groove
46 oblique groove
48 predetermined stable position (closed state)
50 free end
52 circumferential folding line
54 axial folding line
56 oblique folding line
60 force application portion
70 folding section
A axis, axial direction
D diameter
L axial extension, length
R radial direction
S10 to S40 steps of a method of closing a sample tube

1. A sample tube comprising:
a bottom portion,
a tubular portion, and
an opening portion,
wherein the opening portion comprises a foldable structure configured to be foldable in a predetermined manner from an open state into a closed state.

2. The sample tube of claim 1, wherein the closed state is a self-locked closed state.

3. The sample tube of claim 1,
wherein the foldable structure is configured to be folded from the open state to the closed state upon application of at least a radial inward force and at least an axial inward force to at least a portion of the foldable structure.

4. The sample tube of claim 1,
wherein an axial extension of the foldable structure is larger than a radius of the tubular portion.

5. The sample tube of claim 1,
wherein the foldable structure comprises grooves defining folding lines of the foldable structure in the closed state.

6. The sample tube of claim 5,
wherein the grooves are formed on an outer circumferential surface of the opening portion and/or on an inner circumferential surface of the opening portion.

7. The sample tube of claim 5,
wherein the grooves comprise:
a circumferential groove,
a plurality of axial grooves extending axially between the circumferential groove and an axial free end of the opening portion, and
a plurality of oblique grooves extending obliquely between the circumferential groove and the axial free end of the opening portion,
wherein optionally, the circumferential groove, the axial grooves and/or the oblique grooves are connected.

8. The sample tube of claim 1,
wherein in the closed state, a plurality of substantially symmetrical folding sections are radially folded inward.

9. The sample tube of claim 1,
wherein the foldable structure is formed integrally with the opening portion.

10. The sample tube of claim 1, wherein the sample tube is configured to be closable with a separate cap member or plug member when in the open state.

11. The sample tube of claim 10, wherein an outer circumferential surface of the opening portion includes a thread, such that the sample tube is configured to be closable with a threaded cap member.

12. A sample tube closing device for closing a sample tube according to claim 1, the sample tube closing device comprising:
a pressing element configured such that upon operation of the sample tube closing device, at least a portion of the foldable structure is first radially pressed inwards and subsequently at least partially pressed inwards axially to fold the foldable structure into the closed state.

13. The sample tube closing device of claim 12,
wherein the sample tube closing device is operated by an axial displacement and/or a rotational displacement with respect to the sample tube.

14. A method for closing a sample tube, the method comprising
the steps of
providing the sample tube, the sample tube having a foldable structure, at an opening portion;
radially pressing at least a portion of the foldable structure radially inwards; and
axially pressing at least a portion of the foldable structure axially inwards into a closed state.

15. The method of claim 14, the method comprising the step of:
pressing at least a portion of the foldable structure in a direction between a radial inward direction and a circumferential direction of the sample tube.

16. The sample tube of claim 8, wherein the number of folding sections is four.

17. The method of claim 15, wherein the step of pressing the portion of the foldable structure in the direction between the radial inward direction and the circumferential direction of the sample tube is performed
